(19) United States
(12) Patent Application Publication
(10) Pub. No.: US 2009/0230701 A1
(43) Pub. Date: Sep. 17, 2009

(54) Card insertion module locking device of a housing

(76) Inventors: Li-Fu Chiang, Yonghe City (TW); Yu-Hsu Sun, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,895

(22) Filed: May 23, 2009

Related U.S. Application Data
(63) Continuation-in-part of application No. 12/071,933, filed on Feb. 28, 2008.

(51) Int. Cl. E05C 1/08

(52) U.S. Cl. 292/140

(57) ABSTRACT

A locking device for a card insertion module of a housing includes a casing, a movable rod, a locking element, and an elastic member. The movable rod penetrates a channel of the casing. With the restriction of the movable rod and the design of the pushing member, the movable rod moves a distance with respect to the casing. With the action of the movable rod, the locking element pivotally connected to the casing can be rotatably accommodated in the casing. The elastic member is disposed on the casing, so that the movable rod can be kept movable in the channel. The cooperation of the holding slots of the casing with the holding means of the elastic member permanently fixes the elastic member to the casing. Further, through reinforcement of the movable rod and the elastic member, the structural strength of these two components is enhanced, thereby preventing structural deformation.

### CROSS-REFERENCE TO RELATED APPLICATIONS

This application is a continuation-in-part of application Ser. No. 12/071,933, filed on 28 Feb. 2008, and entitled “LATCH DEVICE FOR A CARD INSERTION MODULE OF A CASE”.

### BACKGROUND OF THE INVENTION

1. Field of the Invention

The present invention relates to an insertion card module, and in particular, to a card insertion module locking device of a housing, wherein the card insertion module locking device is for fixing and activating a panel on a housing of an industrial computer.

2. Description of Related Art

With the advancement of data processing technology, computers are widely used in offices or industrial factories to process and store massive and complicated data. The circuit board of a computer is installed in the housing, and frame plates of the housing are fixed and locked to the housing via bolts, screws or the like. Alternatively, side plates of the housing are fixed to the housing via locking members. Since there is a tendency toward compact and light products, the design of computer housing becomes stricter because the fixation by bolts has advantages as follows.

Since the spatial dimension of the product is minimized continuously, the available space for locking the housing is restricted inevitably. Thus, it is more difficult to design the housing due to narrow and insufficient space. With regard to the convenience in assembly, if the housing is assembled via bolts or screws, a tool has to be used to disassemble or lock the bolts or screws one by one, which makes the whole procedure more complicated. With regard to the production cost, if the housing is assembled via bolts or screws, a certain amount of screws is necessary, which makes the assembly of the housing more time-consuming and raises the material cost. According to the above reasons, in terms of cost, assembling efficiency or spatial utilization, it is troublesome for the user or the operator to assemble the housing via screws.

Consequently, because of the above limitation resulting from the technical design of prior art, the inventor strives via real world experience and academic research to develop the present invention, which can effectively improve the limitations described above.

### SUMMARY OF THE INVENTION

The objective of the present invention is to provide a card insertion module locking device of a housing, wherein the card insertion module locking device is for fixing and locking panels on the housing of an industrial computer, whereby the panels can be fixed and inserted easily. A plurality of holding slots is provided in the housing. The elastic member has a plurality of holding members to correspond to the holding slots. With the cooperation between the holding slots and the holding members, the elastic member may be fixed to the casing so as to restrict a movable rod in a channel. As a result, the movable rod may move with respect to the elastic member, and the restricting means is movable with respect to a restricting piece to specific positions, thereby unlocking, locking, and power-activating the panels of the industrial housing.

Another objective of the present invention is to reduce the difficulty in assembling the card insertion module locking device of a housing and reduce the production cost via the cooperation between the holding slots of the housing and the holding members of the elastic member. Since the movable rod moves constantly, the elastic member can always be kept on the casing without slippage or falling.

A further objective of the present invention is to increase the structural strength of the movable rod via a pushing member of the movable rod. In this way, the movable rod can push the locking member efficiently to guarantee the unlocking or locking action of the locking device. With the structural reinforcement of the elastic member, the overall structural strength can be increased. Thus, the deformation of the overall structure can be prevented, and the restricting effect between the restricting means and the restricting piece can be produced without failure.

To achieve the above-mentioned objective, the present invention provides a card insertion module locking device of a housing, which includes: casing, a movable rod, a locking element, and an elastic member. The casing has a channel and an accommodating trough to correspond to the channel. The movable rod penetrates into the channel of the casing. The movable rod has a restricting means and a pushing means. The restricting means is used to restrict the moving distance of the movable rod. The pushing means is provided with a groove. Both sides of the pushing means are provided with a pushing element to correspond to the groove respectively. The locking element is pivotally connected between the casing and the groove. The locking element is located in the channel. The locking element has a first action surface and a second action surface. The first action surface is an inclined plane formed on the upper side of the locking element. The second action surface is a curved plane formed on the lower side of the locking element. Via the movement of the movable rod, the pushing element abuts the second action surface to push the locking element freely, so that the locking element can be either accommodated in the accommodating trough or moved away from the accommodating trough. An elastic member is provided in the casing and accommodated in the channel correspondingly to restrict the movement of the movable rod in the channel. The elastic member has a restricting piece corresponding to the restricting means and a reinforcement piece. The reinforcement piece is fixed to one side of the casing. The casing has a plurality of holding slots. The elastic member has a plurality of holding means to correspond to the holding slots. The cooperation of the holding slots with the holding means firmly disposes the elastic member on the casing, thereby restricting the movable rod in the channel.

Via the above arrangement, when the movable rod moves with respect to the elastic piece, the restricting means can move with respect to the restricting piece at specific positions, so that the locking element can rotate with respect to the accommodating trough. With the cooperation between the holding slots and the holding means, the card insertion module locking device of a housing can be assembled more easily, thereby reduces the production cost. Even though the movable rod moves constantly, the elastic member can always be kept on the casing without being disconnected.

Moreover, with the reinforcement of the pushing element, the structural strength of the movable rod can be increased, so that the movable rod can push the locking member more efficiently to guarantee the unlocking or locking action of the locking device.

Moreover, with the structural reinforcement of the elastic member, the overall structural strength can be increased. Thus, the deformation of the overall structure can be prevented. The restricting effect between the restricting means and the restricting piece can be produced without failure.

In order to further understand the techniques, means, and effects of the present invention takes for achieving the prescribed objectives, the following detailed descriptions and appended drawings are hereby referred; such that, through which the purposes, features, and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is an exploded perspective view of the card insertion module locking device of a housing according to the present invention in one viewing angle;

FIG. 2 is an exploded perspective view of the card insertion module locking device of a housing according to the present invention in another viewing angle;

FIG. 3 is an assembled perspective view of the card insertion module locking device of a housing according to the present invention in one viewing angle;

FIG. 4 is an assembled perspective view of the locking device card insertion module locking device of a housing according to the present invention in another viewing angle;

FIG. 5 is a plane view showing the assembled state of the card insertion module locking device of a housing according to the present invention;

FIG. 6 is a schematic view showing the action of the pushing element of the present invention pushing the locking element;

FIG. 7 is a perspective view showing the unlocked state of the card insertion module locking device of a housing according to the present invention after being assembled;

FIG. 8 is a perspective view showing the locked state of the card insertion module locking device of a housing according to the present invention after being assembled;

FIG. 9 is a perspective view showing the power-activated state of the card insertion module locking device of a housing according to the present invention after being assembled; and

FIG. 10 is an assembled perspective view showing another embodiment of the card insertion module locking device of a housing according to the present invention.

### DETAILED DESCRIPTION OF THE PREFERRED EMBODIMENTS

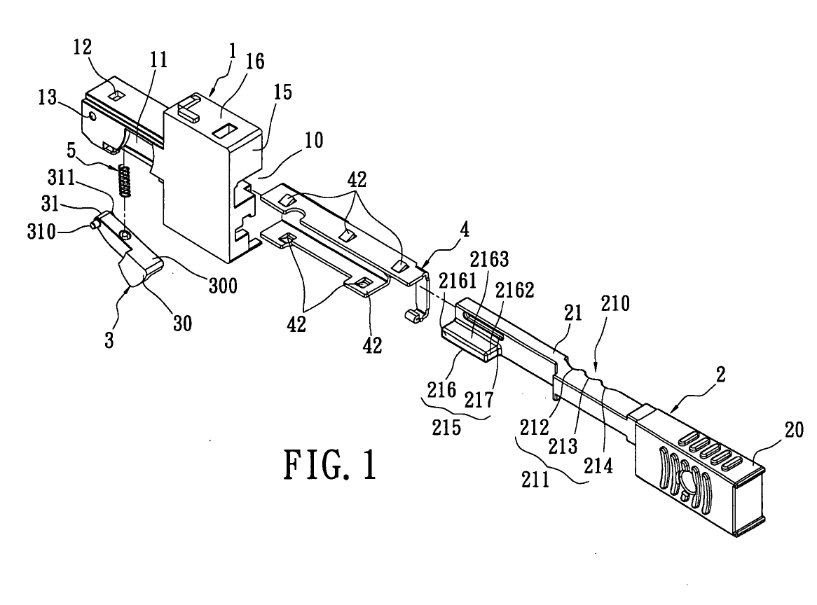

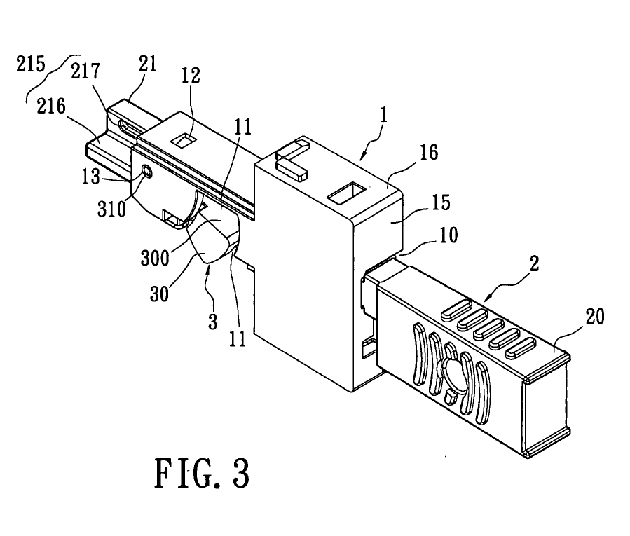

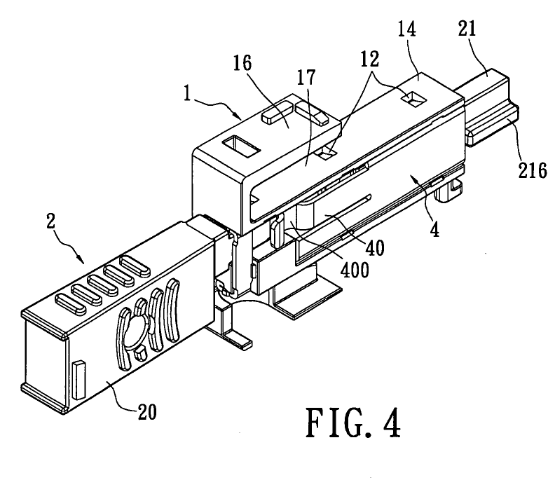

Please refer to FIGS. 1 to 5, which show related drawings of the embodiments of card insertion module locking device of a housing according to the present invention. The present invention is assembled with a fixed base (not shown) on the rear side of an industrial casing, thereby unlocking, locking, and power-activating the panels of the industrial casing. The card insertion module locking device of a housing includes a casing 1, a movable rod 2, a locking element 3, and an elastic member 4.

The casing 1 is made of a metallic material, and within the casing 1 provides a channel 10, an accommodating trough 11 corresponding to the channel 10, a plurality of holding slots 12 corresponding to the channel 10, and a pivotal hole 13 corresponding to the channel 10. The channel 10 is made narrow and elongate, so that the movable rod 2 can be accommodated therein. The accommodating trough 11 penetrates outside the casing 1 and is formed into a curved shape for allowing the locking element 3 to be accommodated therein. The holding slots 12 are used to fix the elastic member 4. The pivotal hole 13 allows the locking element 3 to be pivoted therein. The casing 1 has a first side surface 14. The holding slots 12 are arranged on the first side surface 14 at intervals. A first plate 15 is connected perpendicularly to the first side surface 14, and a second plate 16 is connected perpendicularly to the first plate 15. The second plate 16 and the first side surface 14 are arranged in parallel and a gap 17 is formed there between.

The movable rod 2 is made of metallic material and is formed into a rectangular strip. The movable rod 2 is disposed in the channel 10 of the casing 1 for reciprocating (i.e. moving back and forth) in the channel 10. The movable rod 2 has a handle 20 and an operating portion 21. The handle 20 can be gripped by a user for pushing or pulling the movable rod. The operating portion 21 is movable in the channel 10. The operating portion 21 has a restricting means 210 and a pushing means 215. The restricting means 210 is formed at the front end of the operating portion 21 for restricting the moving distance of the movable rod 2, thereby positioning the movable rod at different stages. In the present embodiment, the restricting means is made curved with its one surface being formed into a convex surface 211. The convex surface 211 has a first raised section 212, a second raised section 213, and a third raised section 214 that are arranged at intervals to generate an effect of multi-stage positioning. The pushing means 215 is formed at the rear end of the operating portion 21. The pushing means 215 has a pushing element 216 and a groove 217, both of which correspond to each other. The pushing element 216 is made elongate for abutting a power switch (not shown) of a panel and pushing the locking element 3. The pushing element 216 protrudes outwards from both sides of the pushing means 215 respectively. The volume of the pushing element 216 is 10% to 20% of the whole volume of the movable rod 2. The movable rod 2 is used to push the locking element 3. The groove 217 is made narrow and elongate for allowing the locking element 3 to be pivoted thereto and thus slide therein. Via this arrangement, the pushing means 215 can drive the locking element 3 to be either rotatably accommodated in the accommodating trough 11 or moved away from the accommodating trough 11.

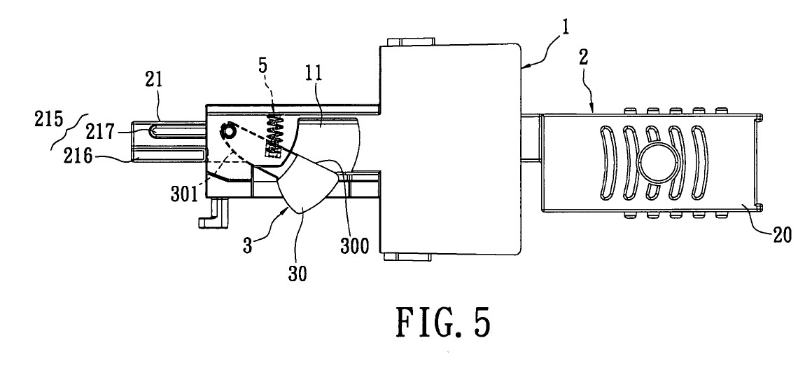

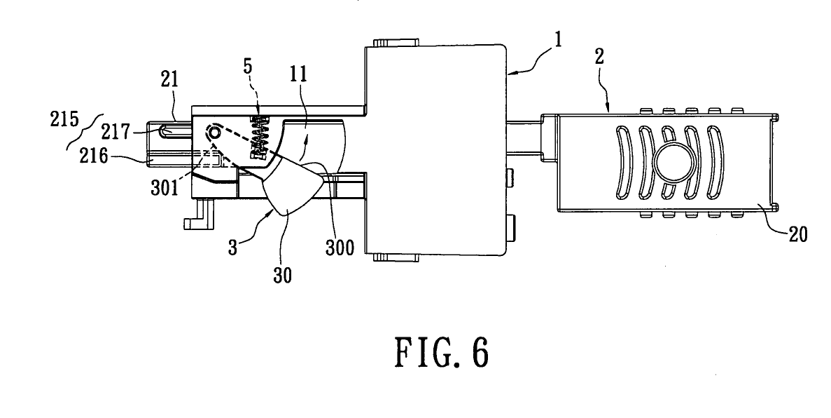

The locking element 3 is made of a metallic material, which is pivotally connected to the casing 1 and is located in the channel 10. Via the movement of the operating portion 21 of the movable rod 2 in the channel 10, the locking element 3 can be driven to be either rotatably accommodated in the accommodating trough 11 or moved away from the accommodating trough 11. The locking element 3 is made of a locking portion 30 and a pivoting portion 31. The locking portion 30 is formed into a curved hook to correspond to the shape of the accommodating trough 11, so that it can be accommodated in the accommodating trough 11. Both side surfaces of the pivoting portion 31 are formed with two rotating pivots 310, 311 respectively. The rotating pivot 310 is pivotally connected to the pivotal hole 13 of the casing 1. The other rotating pivot 311 is movably and pivotally disposed in the groove 217 of the pushing means 215. The two rotating pivots 310, 311 allow the locking portion 30 of the locking element 3 to rotate around. The locking element 3 has a first action surface 300 and a second action surface 301. The first action surface 300 is an inclined plane formed on the upper side of the locking portion 30. The second action surface 301 is a curved plane formed on the lower side of the locking portion 30. The pushing element 216 abuts the second action surface 301, so that the locking element 3 can rotate to be accommodated in the accommodating trough 11. An elastic element 5 is provided between the first action surface 300 and the channel 10 of the casing 1. Since the first action surface 300 is designed to have an inclination, the elastic element 5 can be disposed obliquely on the first action surface 300 (FIG. 5). With the movement of the movable rod 2 and the driving of the rotating pivots 310, 311 as well as the elastic compression or extension of the elastic element 5, the locking element 3 can be either smoothly accommodated in the accommodating trough 11 or moved away from the accommodating trough 11 during its rotation. Since the second action surface 301 is designed as a curved surface, after the movable rod 2 abuts the second action surface 301, the user can push the movable rod 2 freely, so that the locking element 3 can be received in the accommodating trough 11 (FIG. 6). Therefore, since the first action surface 300 is designed to have an inclination, dead corner will not be generated during the action between the elastic element 5 and the locking element 3. In this way, the problems that the locking element 3 cannot rotate smoothly and the locking element 3 fails to lock can be prevented.

The elastic member 4 is provided on the casing 1 and is accommodated in the channel 10, thereby restricting the relative movement of the operating portion 21 of the movable rod 2 in the channel 10. The elastic member 4 has a restricting piece 40, a reinforcement piece 41, and a plurality of holding means 42. The restricting piece 40 is positioned to correspond to the restricting means 210 of the operating portion 21. The restricting piece 40 forms a raised structure 400 to correspond to the convex surface 211 of the restricting means 210. The raised structure 400 can be restricted on the first, the second, and the third raised sections 212, 213, 214. The reinforcement piece 41 is formed on one side of the restricting piece 40. The reinforcement piece 41 is fixed to the casing 1, thereby increasing the overall structural strength of the elastic member 4 and preventing the structural deformation of the elastic member 4. Further, the holding means 42 are fitted respectively in the corresponding holding slots 12, whereby the elastic member 4 can be disposed on the casing 1 efficiently and firmly, and accommodated in the channel 10. In this way, the operating portion 21 can be restricted in the channel 10 at predetermined positions (such as: unlocked position, locked position, or powered position).

Via this arrangement, when the operating portion 21 of the movable rod 2 moves with respect to the elastic member 4, then the first, the second, and the third raised sections 212, 213, 214 of the convex surface 211 of the restricting means 210 will move with respect to the raised structure 400 of the restricting piece 40. With the first, the second, and the third raised sections 212, 213, 214 being restricted selectively by the raised structure 400, the operating portion 21 can be restricted in the unlocked position, locked position, or powered position, thereby respectively unlocking, locking, and power-activating the panels of the industrial housing.

The present invention can lock, unlock, and power-activate the panels of the industrial housing. In addition, the present invention can reduce the difficulty in assembling the card insertion module locking device of a housing, thereby reducing the cost in assembly and production. Since the movable rod 2 moves constantly, the elastic member 4 can always be kept on the casing 1, thereby reducing the possibility of slippage or falling of the elastic member 4. When the movable rod 2 moves with respect to the elastic member 4, the restricting means 210 can move with respect to the restricting piece 40 to restricted positions. In this way, the present invention can achieve the effects of locking, unlocking, and power-activating the panels of the industrial housing.

At the same time, with the reinforced structure of the pushing element 216, the structural strength of the movable rod 2 can be increased, so that the movable rod 2 can push the locking member efficiently. Further, with the construction of the reinforcement piece 41 of the elastic member 4, the overall structural strength can be reinforced so as to prevent undesired deformation.

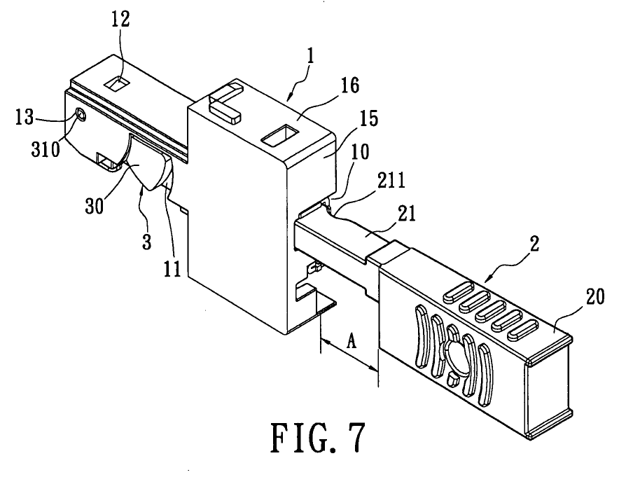

Furthermore, please refer to FIGS. 7 to 9, which show the unlocked, locked, and power-activated states of the card insertion module locking device of a housing according to the present invention after being assembled respectively.

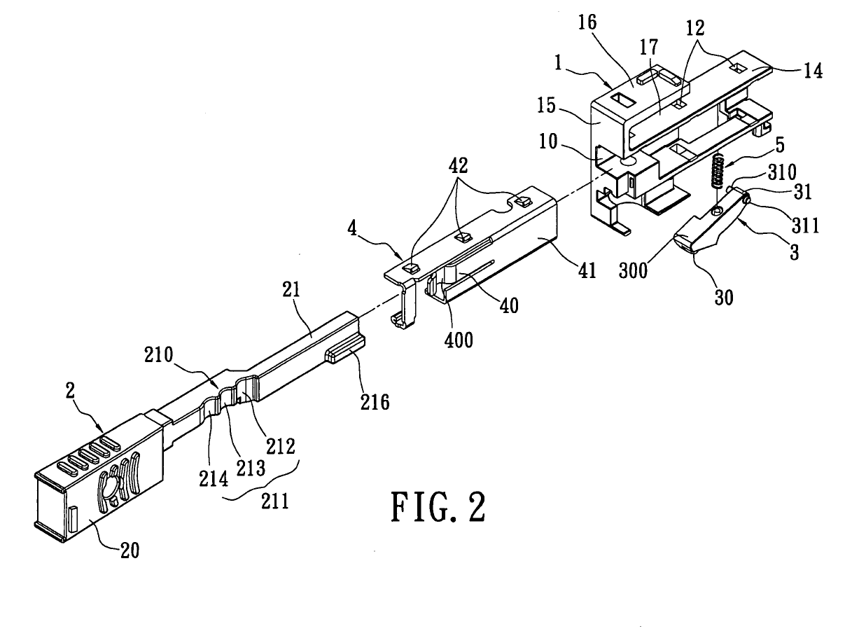

As shown in FIG. 7, when the operating portion 21 of the movable rod 2 moves an unlocking distance A with respect to the casing 1, the cooperation of the restricting piece 40 with the restricting means 210 (FIG. 2) can make the movable rod 2 be restricted to an unlocked position. With the driving of the pushing element 216 of the pushing means 215 (FIG. 1), the elastic element 5 can be compressed (FIG. 5) to push the locking element 3 indirectly, causing the locking element 3 to rotate into the accommodating trough 11. As a result, the locking element 3 forms an unlocked state.

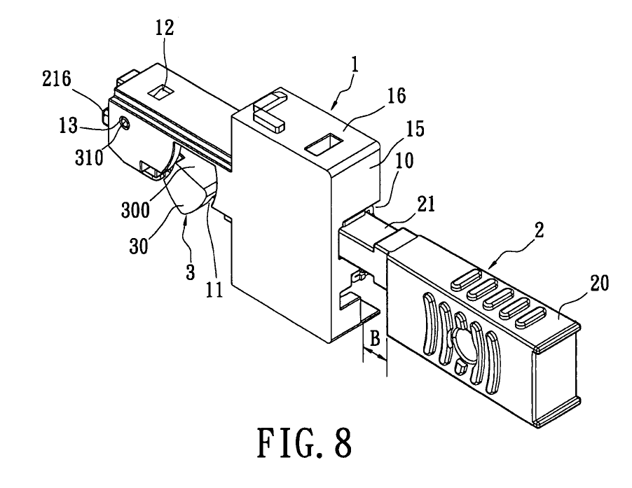

As shown in FIG. 8, when the operating portion 21 of the movable rod 2 moves a locking distance B with respect to the casing 1, the cooperation of the restricting piece 40 with the restricting means 210 (FIG. 2) makes the movable rod 2 be restricted to a locked position. Further, with the elastic extension of the elastic element 5 (FIG. 5), the locking element 3 can be forced to move away from the accommodating trough 11. As a result, the locking element 3 forms a locked state.

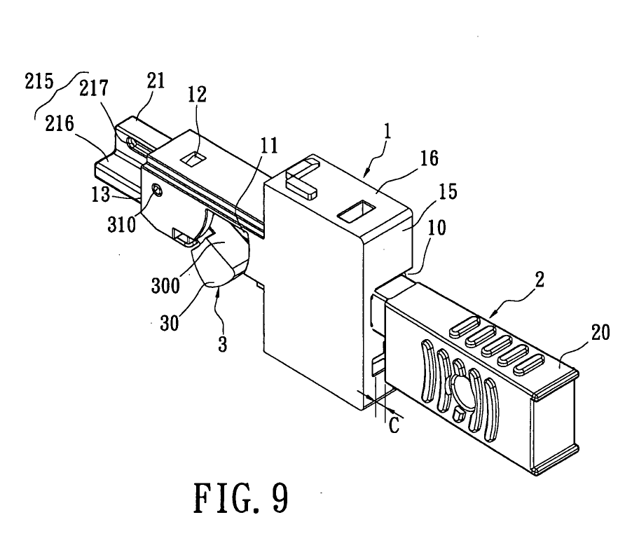

As shown in FIG. 9, when the operating portion 21 of the movable rod 2 moves a power-activation distance C with respect to the casing 1, the cooperation of the restricting piece 40 with the restricting means 210 (FIG. 2) makes the movable rod 2 be restricted to a power-activation position. Further, with the pushing element 216 of the pushing means 215 of the operating portion 21 contacting a switch of the panel of the industrial housing (FIG. 5), the panel forms a power-activated state.

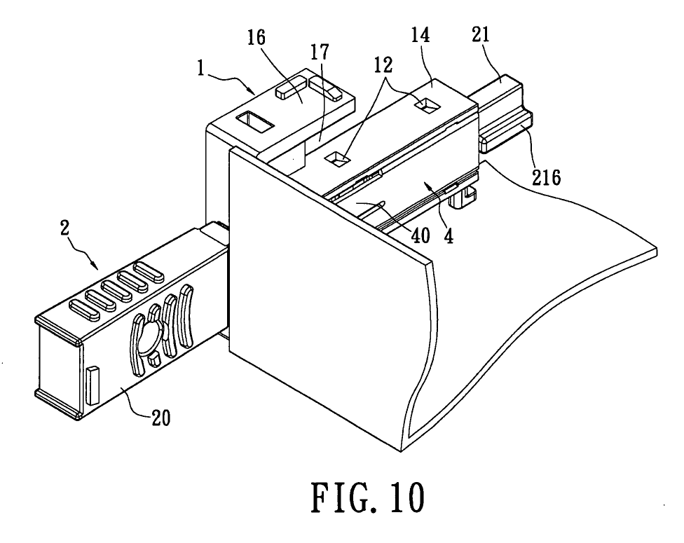

As shown in FIG. 10, the width of the gap 17 can be changed according to the size of the panel to be clamped. When the gap 17 is larger, the size of the panel to be clamped is larger accordingly.

According to the above, the present invention has advantageous features as follows.

(1) Via the cooperation of the holding slots 12 with the holding means 42, the elastic member 4 can be disposed on the casing 1 firmly, thereby restricting the movable rod 2 in the channel 10. In this way, the movable rod 2 can be restricted to specific positions within the channel. The movement of the movable rod 2 with respect to the elastic member 4 can achieve an effect of unlocking, locking, and power-activating the panel.

(2) Since the panel of the industrial housing can be unlocked, locked, and power-activated, the difficulty in assembling the card insertion module locking device of a housing can be reduced. Thus, the cost of assembly and production can be reduced.

(3) No matter whether the movable rod 2 moves frequently or not, the elastic member 4 can always be kept on the casing 1, thereby reducing the possibility of its slippage or falling.

(4) Since the first action surface 300 of the locking element 3 is designed to have an inclination, the elastic compression or extension of the elastic force of the elastic element 5 makes the locking element 3 to be either accommodated in the accommodating through 11 or moved away from the accommodating trough 11 during its rotation. In this way, dead corner will not be generated during the action between the elastic element 5 and the locking element 3.

(5) The pushing means of the movable rod 2 can be reinforced to enhance the structural strength of the movable rod. In this way, the movable rod 2 can push the locking member 3 more efficiently to guarantee the unlocking or locking of the locking device.

(6) The elastic member is formed into a reinforcement piece to enhance its structural strength, thereby reducing the undesired structural deformation during its constant usage.

(7) The second action surface 301 is designed as a curved surface. After the movable rod 2 abuts the second action surface 301, the user can push the movable rod 2 to move freely. As a result, the locking element 3 can enter the accommodating trough 11.

The above-mentioned descriptions represent merely the preferred embodiment of the present invention, without any intention to limit the scope of the present invention thereto. Various equivalent changes, alternations, or modifications based on the claims of present invention are all consequently viewed as being embraced by the scope of the present invention.

What is claimed is:

1. A card insertion module locking device of a housing, comprising:
a casing having a channel and an accommodating trough corresponding to the channel;
a movable rod penetrating into the channel of the casing, the movable rod having a restricting means and a pushing means, the restricting means being used to restrict the moving distance of the movable rod, the pushing means being provided with a groove, both sides of the pushing means protruding to form a pushing element respectively to correspond to the groove;
a locking element pivotally connected between the casing and the groove, the locking element being located in the channel, the locking element having a first action surface and a second action surface, the first action surface being an inclined surface formed on the upper side of the locking element, the second action surface being a curved surface formed on the lower side of the locking element, the movement of the movable rod making the pushing element to abut the second action surface and thus push the locking element to be either rotatably accommodated in the accommodating through freely or moved away from the accommodating trough freely; and
an elastic member provided on the casing and accommodated in the channel correspondingly, the elastic member restricting the movement of the movable rod in the channel, the elastic member having a restricting piece corresponding to the restricting means and a reinforcement piece, the reinforcement piece being fixed to one side of the casing;
wherein the casing has a plurality of holding slots, the elastic member has a plurality of holding means to correspond to the holding slots, the cooperation of the holding slots with the holding means makes the elastic member to be disposed on the casing firmly and accommodated in the channel.

2. The card insertion module locking device of the housing according to claim 1, wherein the locking element has two rotating pivots pivotally connected to the casing and the groove of the movable rod respectively.

3. The card insertion module locking device of the housing according to claim 1, wherein an elastic element is disposed obliquely between the casing and the first action surface, the elastic element drives the locking element to move away from the accommodating trough.

4. The card insertion module locking device of a housing according to claim 3, wherein the elastic element is provided on the first action surface obliquely.

5. The card insertion module locking device of a housing according to claim 1, wherein the restricting means of the movable rod forms a convex surface having a plurality of raised sections, the restricting piece of the elastic member forms a raised structure to correspond to the convex surface.

6. The card insertion module locking device of a housing according to claim 5, wherein the raised structure is restricted on the convex surface, the raised sections move with respect to the raised structure, the raised sections are selectively positioned on the raised structure.

7. The card insertion module locking device of a housing according to claim 1, wherein the groove is formed into an elongate shape.

8. The card insertion module locking device of a housing according to claim 1, wherein the volume of the pushing element is 10% to 20% of the volume of the movable rod.
